(19) United States
(12) Patent Application Publication
(10) Pub. No.: US 2012/0286133 A1
(43) Pub. Date: Nov. 15, 2012

(54) ELECTRONIC DEVICE, A SUPPORT DEVICE THEREOF AND A MTHOD FOR ASSEMBLING THE SAME

(75) Inventors: Dong-Ying Chen, New Taipei City (TW); Shing-Ming Chang, New Taipei City (TW)

(73) Assignee: WISTRON CORPORATION, New Taipei City (TW)

(21) Appl. No.: 13/432,476

(22) Filed: Mar. 28, 2012

(30) Foreign Application Priority Data
May 13, 2011 (CN) 201110123545.8

(51) Int. Cl. F16M 13/00; B23Q 17/00

(52) U.S. Cl. 248/690; 29/407.09

(57) ABSTRACT

A support device is adapted to be attached on a housing body of an electronic device. The support device includes a support leg and a movable unit. The support leg includes at least one first hook engaging separably at least one first hooking groove of the housing body. The movable unit is connected movably to the support leg, and has a second hook engaging separably a second hooking groove of the housing body. The second hook is movable relative to the first hook against a resilient force of a resilient element from an engaging position, where the first and second hook are not permitted to be disengaged from the first and second hooking grooves, to a releasing position, where the first and second hooks are permitted to be disengaged from the first and second hooking grooves.

### CROSS-REFERENCE TO RELATED APPLICATION

This application claims priority of Chinese Application No. 201110123545.8, filed on May 13, 2011, the disclosure of which is incorporated herein by reference.

### BACKGROUND OF THE INVENTION

1. Field of the Invention

The invention relates to a support device, more particularly to a support device of an electronic device that can be assembled and disassembled without the use of tools, and a method for assembling the support device of the electronic device.

2. Description of the Related Art

An electronic device, such as a display device, may be required to be in a standing configuration (see FIG. 1) for certain applications.

Further referring to FIGS. 2 and 3, a conventional electronic device 9 includes a main body 91 and a pair of support legs 92 that can be removably coupled to two sides of the main body 91. Each of the support legs 92 has a body part 93, three L-shaped hooks 94, a securing board 95 and a securing screw 96. Each of the hooks 94 has a horizontal extending segment 941 and an engaging segment 942 that extends vertically and upwardly from a distal end of the horizontal extending segment 941. A through hole 951 is formed in each of the securing boards 95.

Three L-shaped engaging grooves 911 are formed on each of the two sides of the main body 91 for engaging the three hooks 94 of a corresponding one of the support legs 92 respectively. A rear surface of each side of the main body 91 is formed with a screw hole 912 for threaded engagement with the securing screw 96 of the corresponding one of the support legs 92. Each of the engaging grooves 911 has an opening having a height equal to or slightly shorter than that of the engaging segment 942 of the corresponding one of the hooks 94.

In order to couple the support legs 92 to the main body 91, each of the hooks 94 must be inserted into the corresponding L-shaped engaging groove 911, and be subsequently pushed upwardly such that the engaging member 942 of the hook 94 is engaged with the L-shaped engaging grooves 911, thereby preventing horizontal movement of the support legs 92 with respect to the main body 91. Thus, the through hole 951 of the securing board 95 of each of the support legs 92 is registered with the corresponding screw hole 912. Subsequently, each of the securing screws 96 is inserted through the corresponding through hole 951 and the corresponding screw holes 912 for threadedly engaging the body part 93 of the corresponding support leg 92 to the main body 91. As such, vertical movement of the support legs 92 with respect to the main body 91 is prevented, and the assembling of the support legs 92 to the device body 91 is completed. However, the conventional electrical device 9 has several drawbacks. For example, the use of tools (such as a screw driver) is required during assembling processes involving the securing screws 96. Moreover, the screw holes 912 are exposed when the support legs 92 are separated from the main body 91, which may be regarded as an aesthetic disadvantage. Furthermore, since the securing screws 96 are needed for the assembly of the electronic device 9, safekeeping of the securing screws 96 is important when the support legs 92 are not assembled to the main body 91.

### SUMMARY OF THE INVENTION

Therefore, the object of the present invention is to provide a support device of an electronic device that that can be assembled and disassembled without the use of tools.

Accordingly, a support device of the present invention is adapted to be attached on a housing body of an electronic device. The housing body has a first assembling surface. The housing body further has at least one L-shaped first hooking groove that is formed in the first assembling surface and that has a distal portion extending in a first direction. The housing body further has an L-shaped second hooking groove that is formed in the first assembling surface and that has a distal portion extending in a second direction opposite to the first direction. The support device comprises a support leg, a movable unit and a resilient element.

The support leg includes a leg body that has a second assembly surface, and at least one first hook that is adapted to engage separably the at least one first hooking groove. The at least one first hook has a first extending segment that protrudes from the first assembling surface, a first positioning segment that extends in the first direction from a distal end of the first extending segment. The movable unit has a main part that is connected movably to the second assembling surface of the leg body, and a second hook that is adapted to engage separably the second hooking groove. The second hook has a second extending segment that protrudes from the main part toward the first assembling surface of the housing body of the electronic device, and a second positioning segment that extends in the second direction from a distal end of the second extending segment.

The resilient element has a first end that is fixed on the support leg and an opposite second end that is connected to the main part of the movable unit.

The second hook is movable relative to the at least one first hook against a resilient force of the resilient element from an engaging position, where the at least one first hook and the second hook are not permitted to be disengaged respectively from the at least one first hooking groove and the second hooking groove of the housing body of the electronic device, to a releasing position, where the at least one first hook and the second hook are permitted to be disengaged respectively from the at least one first hooking groove and the second hooking groove.

Another object of the present invention is to provide a method of assembling the support device of the electronic device.

Accordingly, a method of assembling the support device of the electronic device of the present invention comprises the following steps of:

a) extending the second hook into the second hooking groove and moving resiliently the support device relative to the second hook under an abutment of the second hook against an inner surface of the second hooking groove, such that the at least one first hook is registered with the at least one first hooking groove;

b) rotating the support device to insert the at least one first hook into the at least one first hooking groove; and

c) releasing resiliently the second hook back to the original position to engage the at least one first hook and the second hook respectively with the at least one first hooking groove and the second hooking groove.

Still another object of the present invention is to provide an electronic device that is configured to stand vertically with support of the supporting device.

Accordingly, an electronic device of the present invention comprises a housing body and a support device.

The housing body includes a first assembling surface that is formed with at least one L-shaped first hooking groove and an L-shaped second hooking groove. The first hooking groove has a distal portion extending in a first direction. The second hooking groove has a distal portion extending in a second direction opposite to the first direction.

The support device includes a support leg, a movable unit and a resilient member.

The support leg includes a leg body that has a second assembly surface, and at least one first hook that that engages separably the at least one first hooking groove. The at least one first hook has a first extending segment that protrudes from the first assembling surface, and a first positioning segment that extends in the first direction from a distal end of the first extending segment.

The movable unit has a main part that is connected movably to the second assembling surface of the leg body, and a second hook that engages separably the second hooking groove. The second hook has a second extending segment that protrudes from the main part toward the first assembling surface of the housing body, and a second positioning segment that extends in the second direction from a distal end of the second extending segment. The resilient element has a first end fixed on the support leg and an opposite second end connected to the main part of the movable unit.

The second hook is movable relative to the at least one first hook against a resilient force of the resilient element from an engaging position, where the at least one first hook and the second hook are not permitted to be disengaged respectively from the at least one first hooking groove and the second hooking groove of the housing body, and a releasing position, where the at least one first hook and the second hook are permitted to be disengaged respectively from the at least one first hooking groove and the second hooking groove.

### BRIEF DESCRIPTION OF THE DRAWINGS

Other features and advantages of the present invention will become apparent in the following detailed description of the embodiment with reference to the accompanying drawings, of which:

FIG. 1 is a front view of a conventional electronic device with two support legs;

FIG. 2 is an exploded front view of the conventional electronic device;

FIG. 3 is a fragmentary exploded rear view of the conventional electronic device;

FIG. 4 is a partly exploded rear view of the embodiment of an electronic device according to the present invention, illustrating a housing body and a pair of an embodiment of a support device;

FIG. 5 is a fragmentary exploded sectional view of the electronic device;

FIG. 6 is a fragmentary exploded perspective view of the electronic device;

FIG. 7 is an assembled perspective view of the embodiment; and

FIGS. 8 to 10 are fragmentary exploded sectional views to illustrate different assembly phases of the embodiment of a method of assembling the electronic device, according to the present invention.

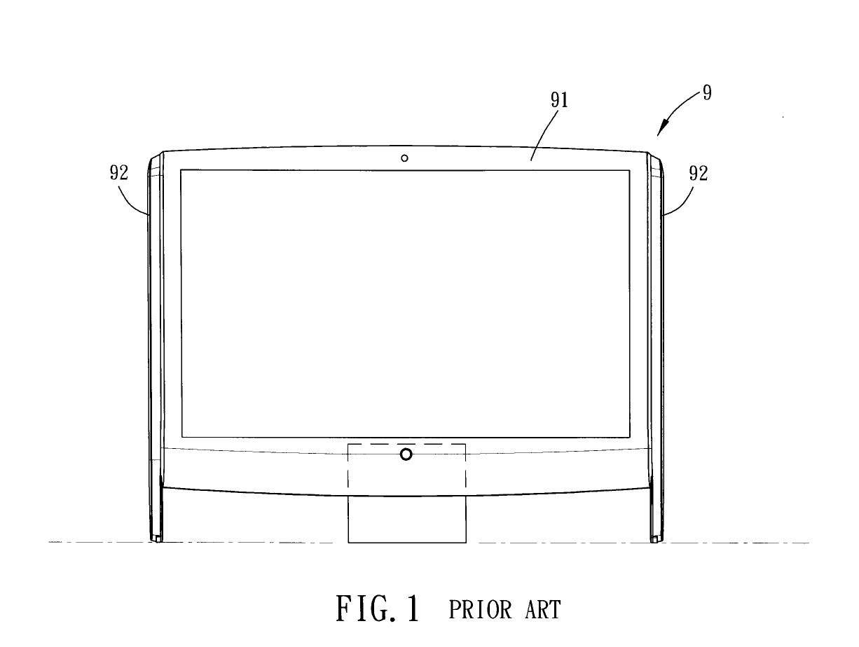

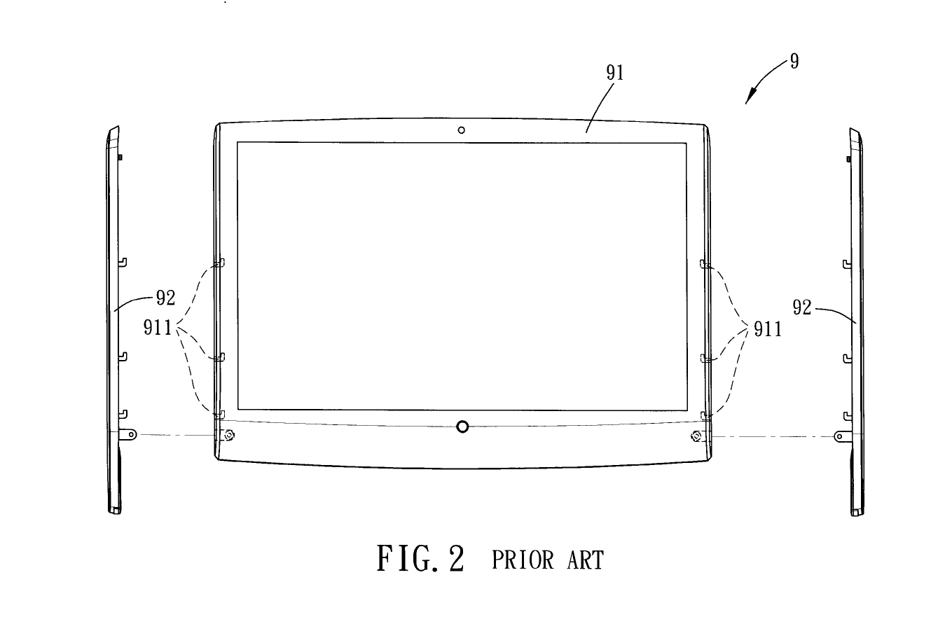

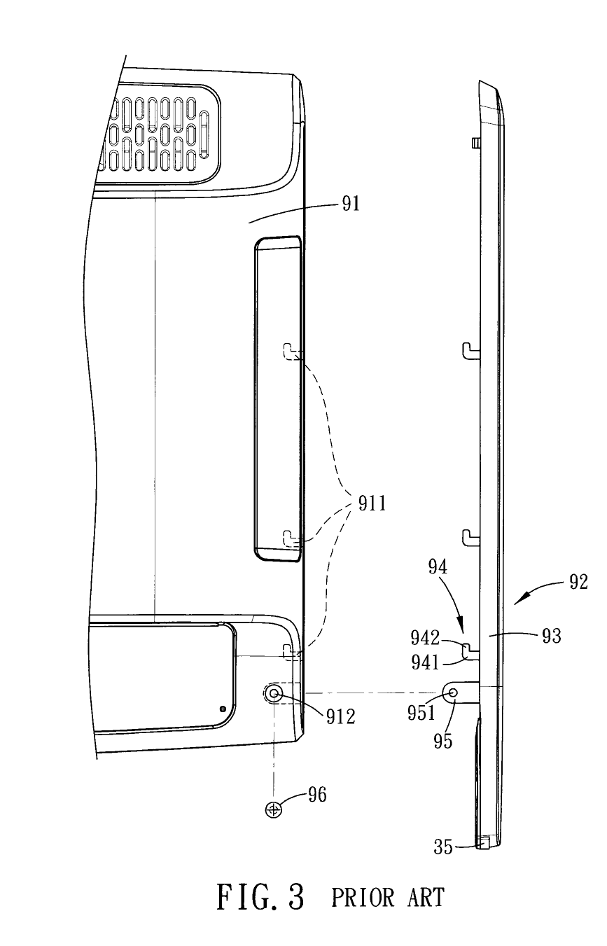

### DETAILED DESCRIPTION OF THE EMBODIMENT

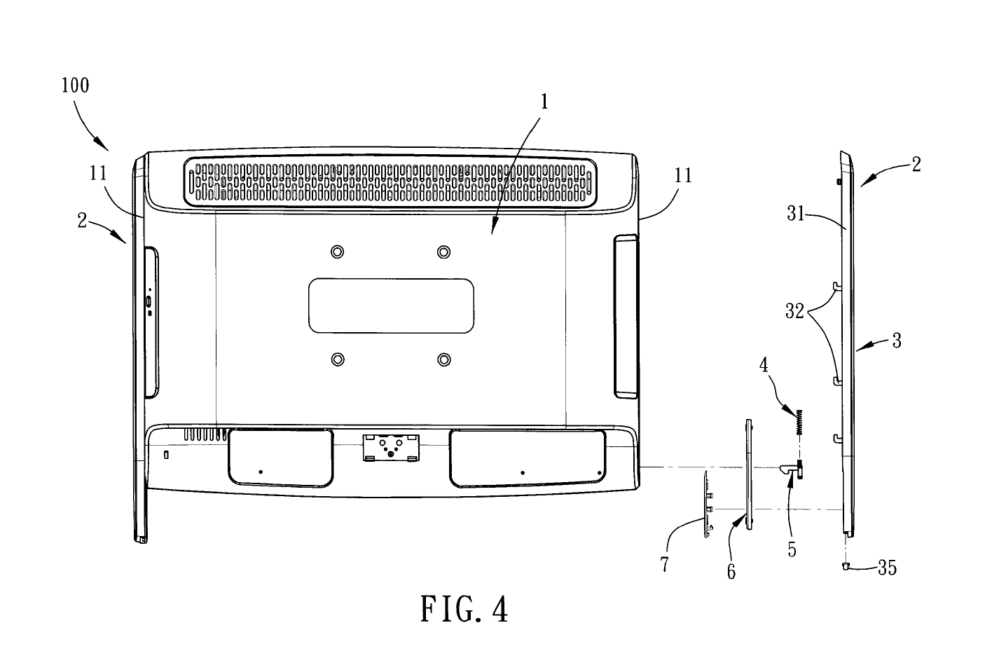

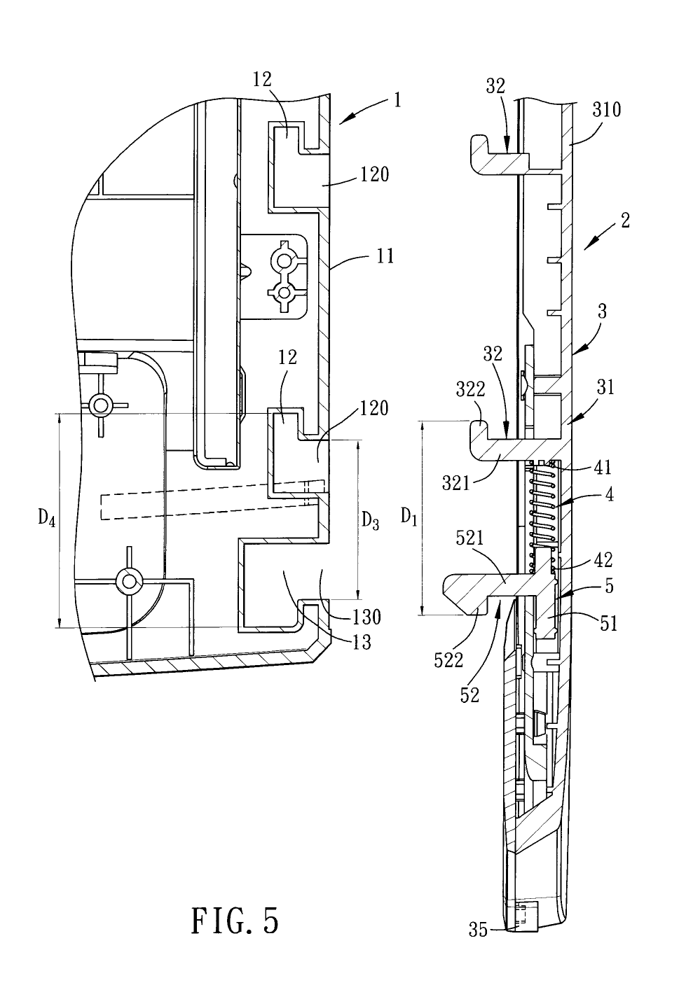

As shown in FIGS. 4 and 5, the embodiment of an electronic device 100 according to the present invention includes a housing body 1 and two support devices 2. The housing body 1 has two lateral sides each formed with a pair of first assembling surfaces 11.

Each first assembling surface 11 is formed with a plurality of spaced-apart L-shaped first hooking grooves 12 and an inverted L-shaped second hooking groove 13. Specifically, each of the first hooking grooves 12 has an extending portion having an open end 120 that is formed in the first assembling surface 11, and a distal portion spatially communicating with the extending portion and extending in an upward first direction. The second hooking groove 13 has an extending portion having an open end 130 that is formed in the first assembling surface 11, and a distal portion spatially communicating with the extending portion and extending in an downward second direction. The first hooking grooves 12 are aligned in the second direction, and the second hooking groove 13 is disposed at a position farther from the farthest one of the first hooking grooves 12 in the second direction (i.e., the second hooking groove 13 is disposed under the lowermost one of the first hooking grooves 12).

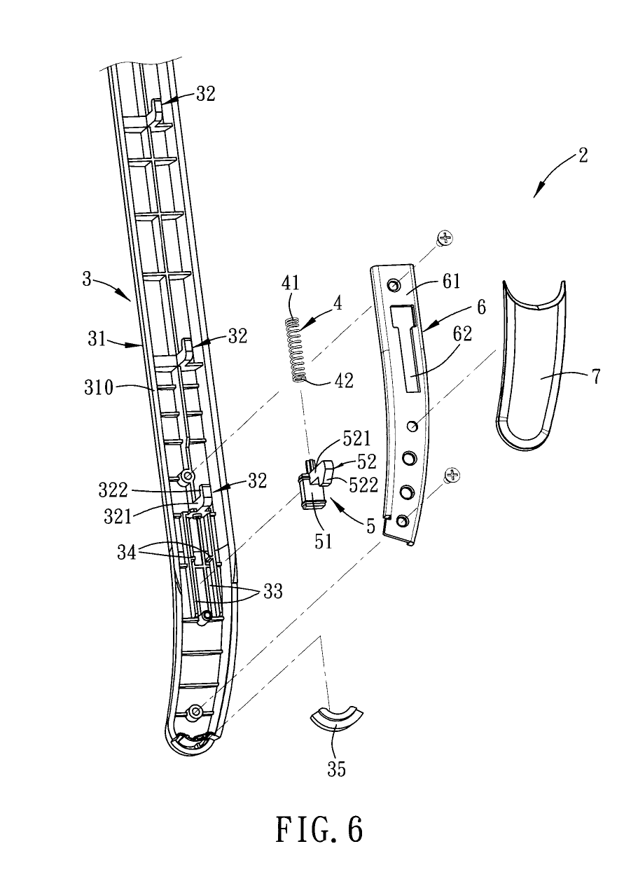

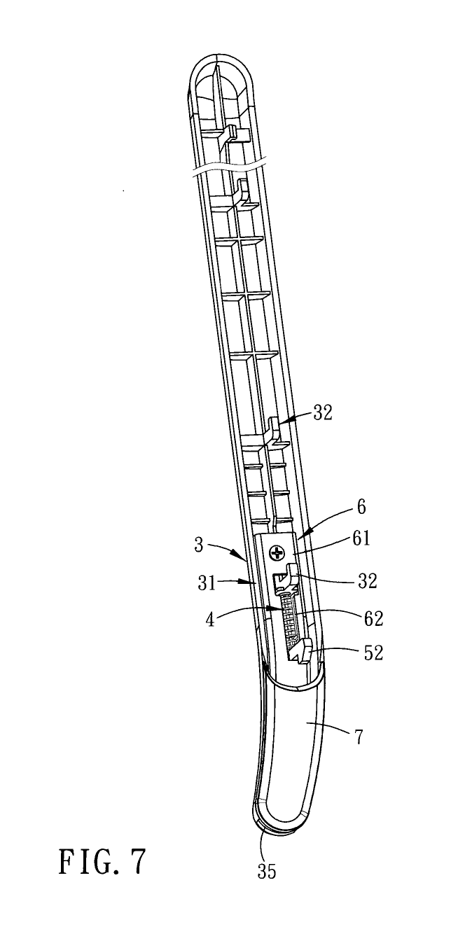

Further reference is made to FIGS. 6 and 7. Each of the support devices 2 comprises a support leg 3, a resilient element 4, a movable unit 5, a reinforcing unit 6 and a lateral covering board 7.

The support leg 3 includes an elongated leg body 31 that has a second assembly surface 310, a plurality of first hooks 32, two vertically-extending constraining ribs 33 that are disposed on said second assembly surface 310 of the leg body 31, two limit blocks 34 that project from the constraining ribs 33, and a base pad 35 fixed on a bottom end of the leg body 31. Specifically, the first hooks 32 are aligned in the second direction for engaging separably and respectively the first hooking grooves 12. Each of the first hooks 32 has a first extending segment 321 that protrudes from the first assembling surface 11, and a first positioning segment 322 extending in the first direction from a distal end of the first extending segment 321. A height of the first positioning segment 322 is slightly shorter than that of the open end 120 of the extending portion of each of the first hooking grooves 12. The constraining ribs 33 are disposed on the second assembling surface 310 at a position farther from the farthest one of the first hooks 32 in the second direction (i.e., the constraining ribs 33 are disposed under the lowermost one of the first hooks 32), are horizontally spaced apart from each other, and cooperate with each other to define a guide space for disposing of the limit blocks 34 therein.

In this embodiment, the resilient element 4 is a compression spring retained between the constraining ribs 33, and having a first end 41 that is fixed on the second assembling surface 310 of the support leg 3 and a second end 42 opposite to the first end 41. The first end 41 is secured to a bottom surface of the lowermost one of the first hooks 32.

The movable unit 5 is movably retained between the constraining ribs 33, and has a main part 51 that is connected movably to the second assembling surface 310 of the leg body 31 and that has a top end connected to the second end 42 of the resilient element 4. The movable unit 5 further has a second hook 52 having a second extending segment 521 that protrudes from the main part 51 toward the first assembling surface 11, and a second positioning segment 522 that extends in the second direction from a distal end of the second extending segment 521. A height of the second positioning segment 522 is slightly shorter than that of the open end 130 of the extending portion of the second hooking groove 13.

The limit blocks 34 project from the constraining ribs 33 into the guide space toward each other and abut against the top end of the main part 51 of the movable unit 5 so as to limit upward movement of the movable unit 5 within the guide space. The reinforcing unit 6 includes an enhancing member 61 that is superposed on the second assembling surface 310 of the leg body 31 of the support leg 3, and a through hole 62 that is formed in the enhancing member 61. In this embodiment, the enhancing member 61 is made of iron, and is screwed onto the support leg 3 to thereby prevent the resilient element 4 and the movable unit 5 from falling out of the support leg 3 and to enhance the structural strength of the support leg 3. The through hole 62 extends in the second direction, the lowermost one of the first hooks 32 and the second hook 52 extends through the through hole 62, and the second hook 52 is movable in the first direction in the through hole 62.

The lateral covering board 7 overlaps the enhancing member 61. Specifically, the lateral covering board 7 covers a part of an outer surface of the enhancing member 61 that faces away from the second assembly surface 310. The lateral covering board 7 serves to protect and aesthetically improve the exposed part of the support device 2.

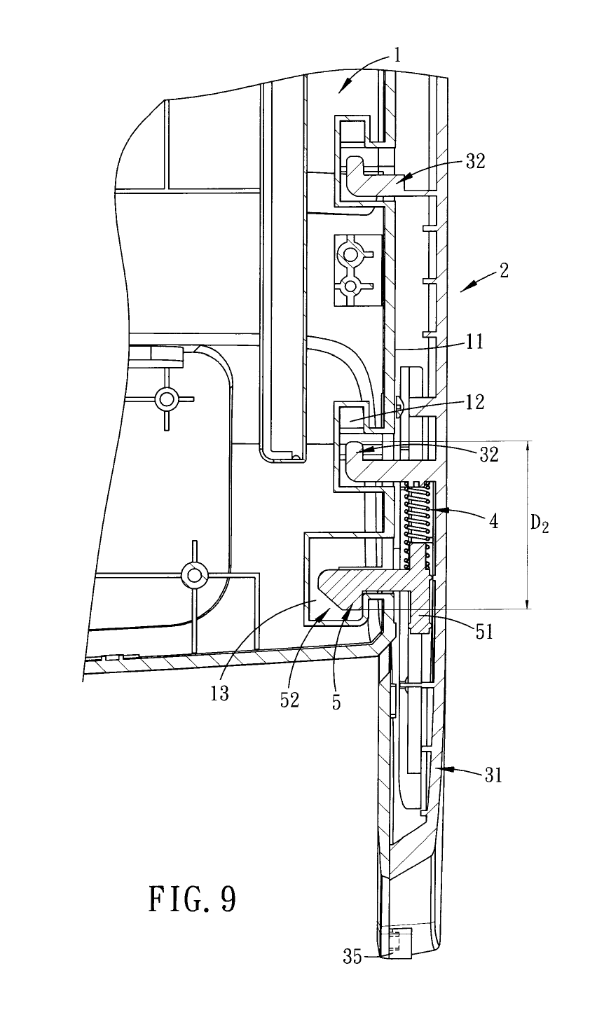

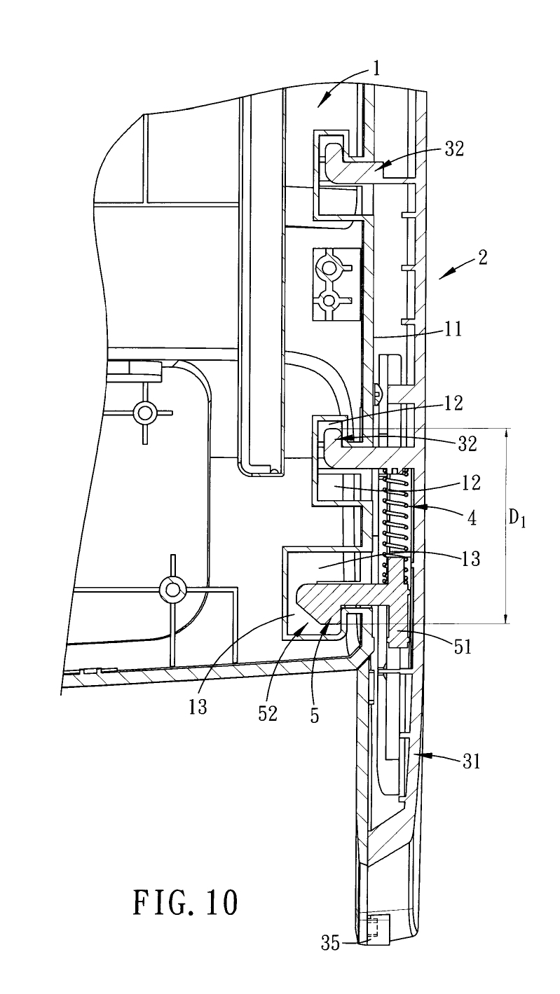

The second hook 52 is movable relative to the first hook 32 against a resilient force of the resilient element 4 from an engaging position (see FIG. 10), where the first and second hooks 32, 52 are not permitted to be disengaged respectively from the first and second hooking grooves 12, 13 of the housing body 1, to a releasing position (see FIG. 9), where said first and second hooks 32, 52 are permitted to be disengaged respectively from the first and second grooves 12, 13.

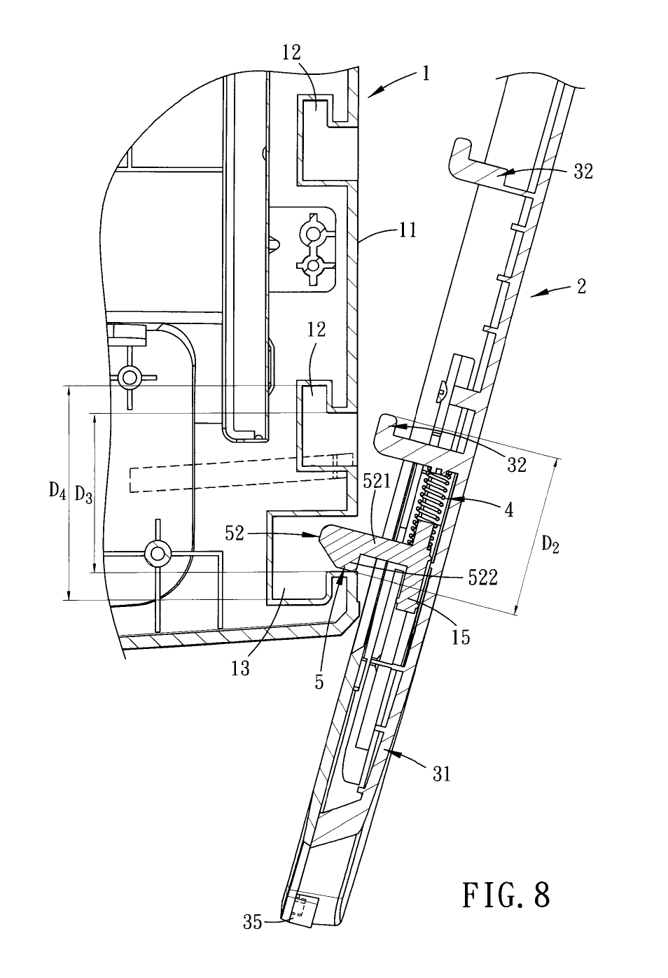

Referring back to FIG. 5, and further referring to FIGS. 8 to 10, when the second hook 52 is at the engaging position, distance between a distal end of the first positioning segment 322 of a closest one (i.e., the lowermost one) of the first hooks 32 is spaced from a distal end of the second positioning segment 522 of the second hook 52 is defined as (D₁). Distance between the distal end of the first positioning segment 322 of the lowermost one of the first hooks 32 and the distal end of the second positioning segment 522 of the second hook 52 when the second hook 52 is at the releasing position is defined as (D₂). Distance between a farthest end of the top end of the open end 120 of the lowermost one of the first hooking grooves 12 in the first direction and a farthest end of the open end 130 of the second hooking groove 13 is defined as (D₃). Distance between distal ends of the distal portions of lowermost one of the first hooking grooves 12 and the second hooking grooves 13 is defined as (D₄). In this embodiment, (D₄)≧(D₁)>(D₃)≧(D₂).

Steps of assembling the support legs 3 to the electronic device 100, according to the present invention, is described hereinafter.

First, as shown in FIG. 8, the support leg 3 is held obliquely with respect to the electronic device 100, and the second hook 52 is extended into the second hooking groove 13. The support device 2 is then moved resiliently relative to the second hook 52 under an abutment of the second hook 52 against an inner surface of the extending portion of the second hooking groove 13 from the engaging position to the releasing position, such that the second hook 52 is moved closer to the lowermost one of the first hooks 32 and the first hooks 32 correspond respectively to the first hooking grooves 12.

Next, the support device 2 is rotated with the second hook 52 serving as a fulcrum, such that the first hooks 32 are inserted respectively into the first hooking grooves 12, as shown in FIG. 9.

Finally, the second hook 52 is released resiliently back to the original position (i.e., the engaging position) to engage the first and second hooks 32, 52 respectively with the first and second hooking grooves 12, 13, thereby completing the assembly of the support device 2.

When the assembly of the support device 2 is complete, the first positioning segment 322 of each of the first hooks 32 is retained in the distal portion of the corresponding one of the first hooking grooves 12, and the second positioning segment 522 of the second hook 52 is retained in the distal portion of the second hooking groove 13, thereby preventing horizontal movement of the support device 2 with respect to the housing body 1, and hence unintentional disengagement of the support device 2 from the housing body 1. Additionally, since the housing body 1 itself and other component therein apply a downward force on the first hooks 32, the first hooks 32 are firmly engaged with the first hooking grooves 12, such that unintentional disengagement of the support device 2 from the housing body 1 can be prevented. Moreover, in such a configuration, when the housing body 1 is lifted, the support devices 2 will not be disengaged and fall off from the housing body 1 unless an additional downward force is applied to each support devices 2 in opposition to the resilient force of the resilient member 4 to thereby relocate the second hook 52 to the releasing position. Accordingly, in order to prevent unintentional disengagement and falling of the support device 2, each resilient member 4 must have a sufficiently large elastic modulus. Preferably, each resilient member 4 must be capable of bearing a force that is 1.5 times larger than a gravitational force resulting from the weight of each support device 2 without deformation.

To sum up, by virtue of the engagement and disengagement mechanism realized by the first and second hooks 32, 52 and the corresponding first and second hooking grooves 12, 13, the assembling and disassembling of the support device 2 can be easily performed without the use of tools(e.g., screws and screw drivers). In addition, since the housing body 1 is not formed with screw holes, the aesthetic quality of the housing body 1 is relatively improved.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A support device adapted to be attached on a housing body of an electronic device, the housing body having a first assembling surface, at least one L-shaped first hooking groove that is formed in the first assembling surface and that has a distal portion extending in a first direction, and an L-shaped second hooking groove that is formed in the first assembling surface and that has a distal portion extending in a second direction opposite to the first direction, said support device comprising:
a support leg including a leg body that has a second assembly surface, and at least one first hook that is adapted to engage separably the at least one first hooking groove, said at least one first hook having a first extending segment that protrudes from said first assembling surface, and a first positioning segment extending in the first direction from a distal end of said first extending segment;
a movable unit having a main part that is connected movably to said second assembling surface of said leg body, and a second hook that is adapted to engage separably the second hooking groove, said second hook having a second extending segment that protrudes from said main part toward the first assembling surface of the housing body of the electronic device, and a second positioning segment that extends in the second direction from a distal end of said second extending segment; and
a resilient element having a first end that is fixed on said support leg and an opposite second end that is connected to said main part of said movable unit;
wherein said second hook is movable relative to said at least one first hook against a resilient force of said resilient element from an engaging position, where said at least one first hook and said second hook are not permitted to be disengaged respectively from the at least one first hooking groove and the second hooking groove of the housing body of the electronic device, to a releasing position, where said at least one first hook and said second hook are permitted to be disengaged respectively from the at least one first hooking groove and the second hooking groove.

2. The support device as claimed in claim 1, the first hooking groove further having an extending portion that communicates with the distal portion thereof and that has an open end formed in the first assembling surface, the second hooking groove further having an extending portion that communicates with the distal portion thereof and that has an open end formed in the first assembling surface, wherein:
a distance between a distal end of said first positioning segment of a closest one of said at least one first hook and a distal end of said second positioning segment of said second hook when said second hook is at the engaging position is defined as (D₁);
a distance between said distal end of said first positioning segment of the closest one of said at least one first hook and said distal end of said second positioning segment of said second hook when said second hook is at the releasing position is defined as (D₂);
a distance between a farthest end of the open end of a farthest one of a closest one of the at least one first hooking groove and the second hooking groove in the first direction and a farthest end of the open end of a farthest one of the closest one of the at least one first hooking groove and the second hooking groove in the second direction is defined as (D₃);
a distance between distal ends of the distal portions of the closest one of the at least one first hooking groove and the second hooking groove is defined as (D₄); and
(D₄)≧(D₁)>(D₃)≧(D₂).

3. The support device as claimed in claim 2, wherein the first direction is an upward direction and the second direction is a downward direction, said support leg further including two vertically-extending constraining ribs that are disposed on said second assembling surface, that are horizontally spaced apart from each other, and that cooperate with each other to define a guide space in which said movable unit is movably retained.

4. The support device as claimed in claim 3, wherein said support leg further having at least one limit block disposed in said guide space for limiting the movement of said movable unit within said guide space.

5. The support device as claimed in claim 1, the housing body of the electronic device being formed with a plurality of the first hooking grooves, wherein said support leg includes a plurality of said first hooks aligned in the second direction and adapted to engage separably and respectively the first hooking grooves, said second hook of said movable unit being disposed at a position farther from the farthest one of said first hooks in the second direction.

6. The support device as claimed in claim 5, further comprising an reinforcing unit including an enhancing member that is superposed on said second assembling surface of said leg body of said support leg, and a through hole that is formed in said enhancing member and that extends in the second direction, the farthest one of said first hooks and said second hook extending through said through hole, said second hook being movable in said through hole.

7. The support device as claimed in claim 6, further comprising a lateral covering board overlapping said enhancing member.

8. A method of assembling a support device of an electronic device, the supporting device including at least one first hook and a second hook that is aligned vertically with the at least one first hook and that is vertically and resiliently movable relative to the at least one first hook, the electronic device including a housing body that is formed with at least one first hooking groove and a second hooking groove, the method comprising the following steps of:
a) extending the second hook into the second hooking groove and moving resiliently the support device relative to the second hook under an abutment of said second hook against an inner surface of the second hooking groove, such that the at least one first hook is registered with the at least one first hooking groove;
b) rotating the support device to insert the at least one first hook into the at least one first hooking groove; and
c) releasing resiliently the second hook back to the original position to engage the at least one first hook and the second hook respectively with the at least one first hooking groove and the second hooking groove.

9. An electronic device comprising:
a housing body including
a first assembling surface,
at least one L-shaped first hooking groove that has a distal portion extending in a first direction, and
an L-shaped second hooking groove that has a distal portion extending in a second direction opposite to the first direction; and
a support device including
a support leg that includes a leg body having a second assembly surface, and at least one first hook engaging separably said at least one first hooking groove, said at least one first hook having a first extending segment that protrudes from said first assembling surface, and a first positioning segment that extends in the first direction from a distal end of said first extending segment,
a movable unit that has a main part connected movably to said second assembling surface of said leg body, and a second hook engaging separably said second hooking groove, said second hook having a second extending segment that protrudes from said main part toward said first assembling surface of said housing body, and a second positioning segment that extends in the second direction from a distal end of said second extending segment, and
a resilient element that has a first end fixed on said support leg and an opposite second end connected to said main part of said movable unit;
wherein said second hook is movable relative to said at least one first hook against a resilient force of said resilient element from an engaging position, where said at least one first hook and said second hook are not permitted to be disengaged respectively from said at least one first hooking groove and said second hooking groove of said housing body, to a releasing position, where said at least one first hook and said second hook are permitted to be disengaged respectively from said at least one first hooking groove and said second hooking groove.

10. The electronic device as claimed in claim 9, wherein:
said at least one first hooking groove further has an extending portion that communicates with said distal portion thereof and that has an open end formed in said first assembling surface, said second hooking groove further having an extending portion that communicates with said distal portion thereof and that has an open end formed in said first assembling surface;
a distance between a distal end of said first positioning segment of the closest one of said at least one first hook and a distal end of said second positioning segment of said second hook when said second hook is at the engaging position is defined as (D₁);
a distance between said distal end of said first positioning segment of the closest one of said at least one first hook and said distal end of said second positioning segment of said second hook when said second hook is at the releasing position is defined as (D₁);
a distance between a farthest end of said open end of a farthest one of a closest one of said at least one first hooking groove and said second hooking groove in the first direction and a farthest end of said open end of a farthest one of said at least one first hooking groove and said second hooking groove is defined as (D₃);
a distance between distal ends of the distal portions of the closest one of said at least one first hooking groove and said second hooking groove is defined as (D₄); and
(D₄)≧(D₁)>(D₃)≧(D₂).

11. The electronic device as claimed in claim 10, wherein the first direction is an upward direction and the second direction is a downward direction, said support leg further including two vertically-extending constraining ribs that are disposed on said second assembling surface, that are horizontally spaced apart from each other, and that cooperate with each other to define a guide space in which said movable unit is movably retained.

12. The electronic device as claimed in claim 11, wherein said support leg further having at least one limit block disposed in said guide space for limiting the movement of said movable unit within said guide space.

13. The electronic device as claimed in claim 9, wherein said housing body is formed with a plurality of said first hooking grooves, said support leg including a plurality of said first hooks that are aligned in the second direction and that engage separably and respectively said first hooking grooves, said second hook of said movable unit being disposed at a position farther from the farthest one of said first hooks in the second direction.

14. The electronic device as claimed in claim 13, further comprising an reinforcing unit including a enhancing member that is superposed on said second assembling surface of said leg body of said support leg, and a through hole that is formed in said enhancing member and that extends in the second direction, the farthest one of said first hooks and said second hook extending through said through hole, said second hook being movable in said through hole.

15. The electronic device as claimed in claim 14, further comprising a lateral covering board overlapping said enhancing member.
